(19) United States
(12) Patent Application Publication
(10) Pub. No.: US 2013/0069941 A1
(43) Pub. Date: Mar. 21, 2013

(54) NAVIGATIONAL AID HAVING IMPROVED PROCESSING OF DISPLAY DATA

(71) Applicants: Jérôme Augui, Meudon (FR); Frédéric Mit, Paris (FR)

(72) Inventors: Jérôme Augui, Meudon (FR); Frédéric Mit, Paris (FR)

(21) Appl. No.: 13/698,165

(22) PCT Filed: May 13, 2011
(86) PCT No.: PCT/FR2011/051081

§ 371 Date: Nov. 15, 2012

(30) Foreign Application Priority Data
May 17, 2010 (FR) 1053795

(51) Int. Cl. G06T 15/00

(52) U.S. Cl. 345/419

(57) ABSTRACT

A technique for processing display data on a screen for a navigational aid between a current position point and a destination point by comparing the distance from the current position with a threshold distance, processing display data, controlling a command of the display on the screen, respectively from the bottom to the top of the screen: a first 3-D representation, according to a perspective defined with a first angle of view in relation to a selected plane, of a panorama separated from the current position point by a distance that is less than said threshold distance; and a second representation, according to a perspective defined with a second angle of view in relation to said selected plane, of a panorama separated from the current position point by a distance that is greater than said threshold distance, the first angle being smaller than the second angle.

The present invention relates to processing of on-screen display data for aiding navigation or more generally for aiding orientation on a journey between a current position point and a destination point.

Numerous mobile or sedentary navigation products offer viewing of a route between a current position point and a destination point, such as:
roaming devices using the GPS system (for “Global Positioning System”),
geo-location applications on mobile sets (personal digital assistants or advanced telephone sets termed “SmartPhones”),
devices for aiding GPS navigation, fixed enduringly in vehicles,
applications downloadable via Internet sites affording presentations of charts or maps,
systems for global viewing (for example of maritime maps),
or else systems for aiding town and/or country rambling journeys.

All these products generally use three types of graphical representation of a part at least of the journey:
a first type of representation, plane, of the whole of the journey, according to a 2D graphic (for example with superposition on a satellite photograph),
a second type of representation, termed in “bird mode” of only the start of the journey from the current position point (often a graphical representation in 2D isometry), and
a third type of 3D representation, in perspective, at the very start of the journey only (first buildings for example of a montage facing the current position point).

There does not currently exist any device affording a combination of several of these representations, each representation excluding in principle another of these representations.

For example, the third type of representation does not make it possible to give a global depiction of the route that the user wishes to follow. The first or the second type of representation does not make it possible to reduce apprehension related to an unknown journey.

The present invention improves the situation.

It proposes for this purpose a method for processing on-screen display data for aiding orientation between a current position point and a destination point, the on-screen display comprising at least one 3D representation of a panorama facing said current position point according to a current direction of travel. The method within the meaning of the invention comprises:
a step of comparing a distance from the current position point, with at least one threshold distance, and
a step of processing display data, as a function of said comparison, so as to control a command of the on-screen display with at least, respectively from the bottom of the screen to the top of the screen:
   a first 3D representation according to a perspective defined with a first angle of view with respect to a chosen plane, of a panorama separated from the current position point by a distance which is less than said threshold distance, and
   a second representation according to a perspective defined with a second angle of view with respect to said chosen plane, of a panorama separated from the current position point by a distance which is greater than said threshold distance,
the first angle being less than the second angle.

Thus, the implementation of the present invention makes it possible to represent at one and the same time, in the course of one and the same on-screen display:
a 3D detail view, in perspective, for example of the first buildings of a panorama facing the current position point, and
a more overall view, with a larger angle of perspective, of the buildings according to this panorama.

The implementation of the present invention then makes it possible to offer the user greater comfort while traveling, by reducing his stress burden. It makes it possible in particular to simplify a user's perception of a given path and future actions to be performed. It allows him to optimize anticipation and then offers better apprehension of the context.

Thus, the present invention eases reading, the memorizing of information and, consequently, reduces the user's mental burden, limiting in particular the risks of driver inattentiveness and, in fact, the risks of vehicle accident.

The aforementioned chosen plane may be generally a horizontal plane. However, in a particular embodiment where the type of 3D representation chosen takes account of a geological relief, this plane may not be strictly horizontal.

The present invention is also aimed at a computer program comprising instructions for the implementation of the method such as defined hereinabove or such as will be described in greater detail hereinafter with reference to the drawings, when this program is executed by a processor. The algorithm of such a program can be represented by the flowchart illustrated in FIG. 8 commented on hereinafter.

The present invention is also aimed at a module for processing on-screen display data for aiding orientation between a current position point and a destination point. This module comprises, in particular, means for the implementation of the method such as defined hereinabove or such as will be described in greater detail hereinafter with reference to the drawings. In particular, an exemplary embodiment of such a module is illustrated in FIG. 2 commented on hereinafter.

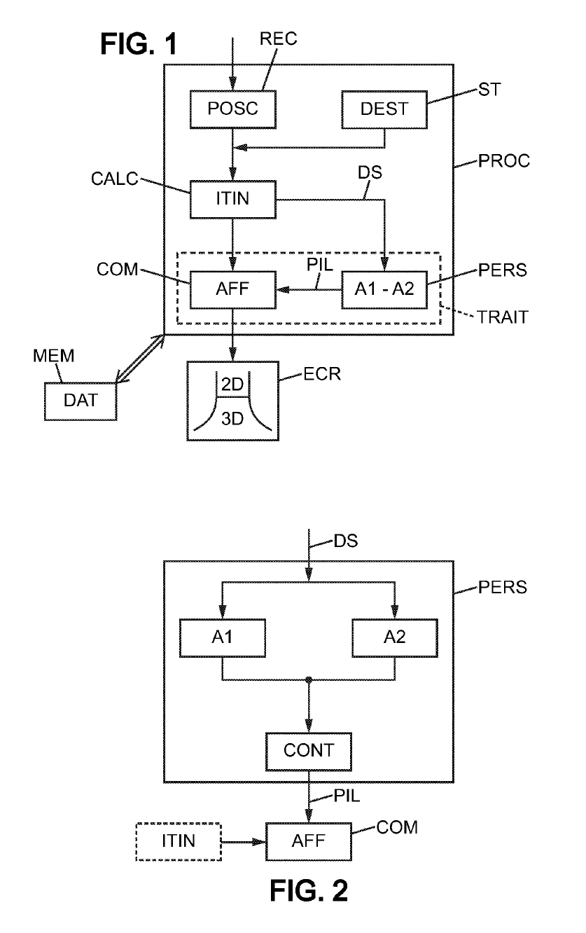

The present invention is also aimed at a device for aiding orientation, for example for aiding navigation, between a current position point and a destination point, and comprising in particular a module for processing display data within the meaning of the invention. In particular, an exemplary embodiment of such a device is illustrated in FIG. 1 commented on hereinafter.

Moreover, other characteristics and advantages of the invention will be apparent on examining the detailed description hereinafter, and the appended drawings in which:

FIG. 1 illustrates an exemplary device for the implementation of the method within the meaning of the invention;

FIG. 2 illustrates an exemplary module for processing graphical data included in such a device for the implementation of the method within the meaning of the invention;

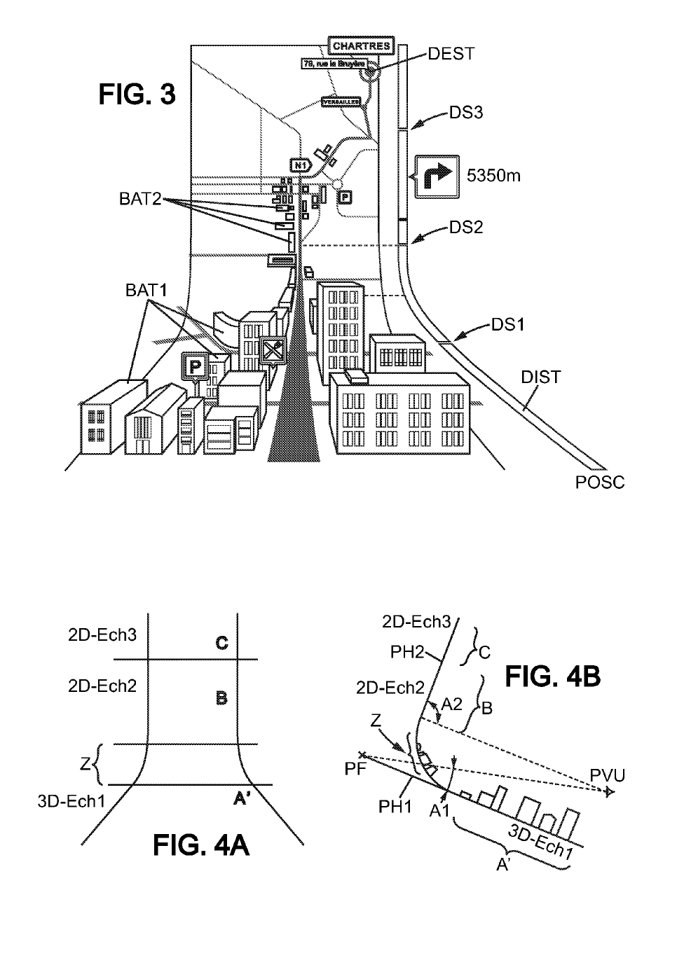

FIG. 3 represents an exemplary on-screen display within the meaning of the invention;

FIGS. 4A and 4B illustrate respectively in end-on and sectional views the projections calculated by the module within the meaning of the invention for the display represented in FIG. 3;

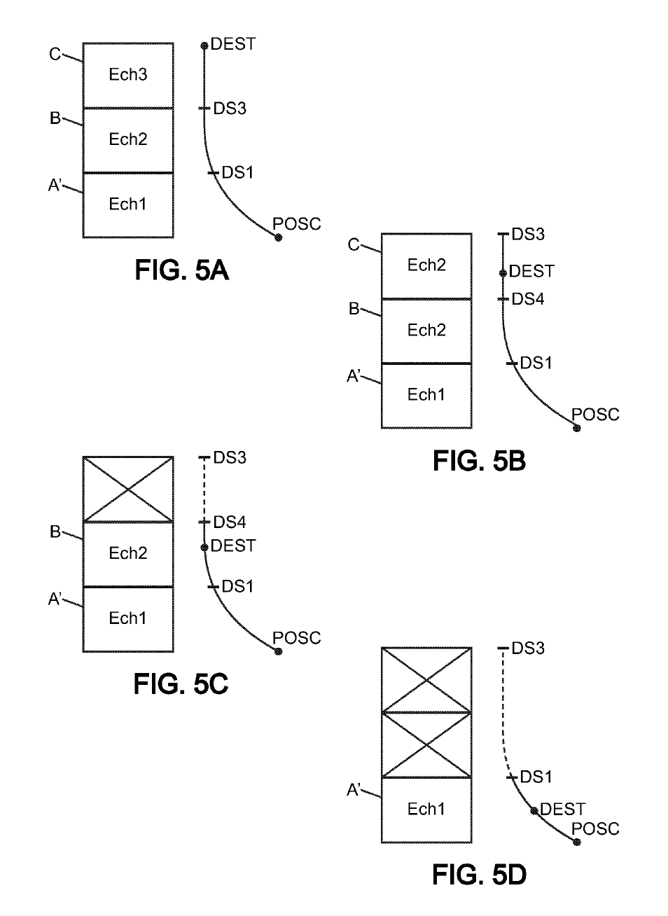

FIGS. 5A to 5D illustrate the changes of scales in various zones of the display within the meaning of the invention, as a function of the distance remaining to be covered;

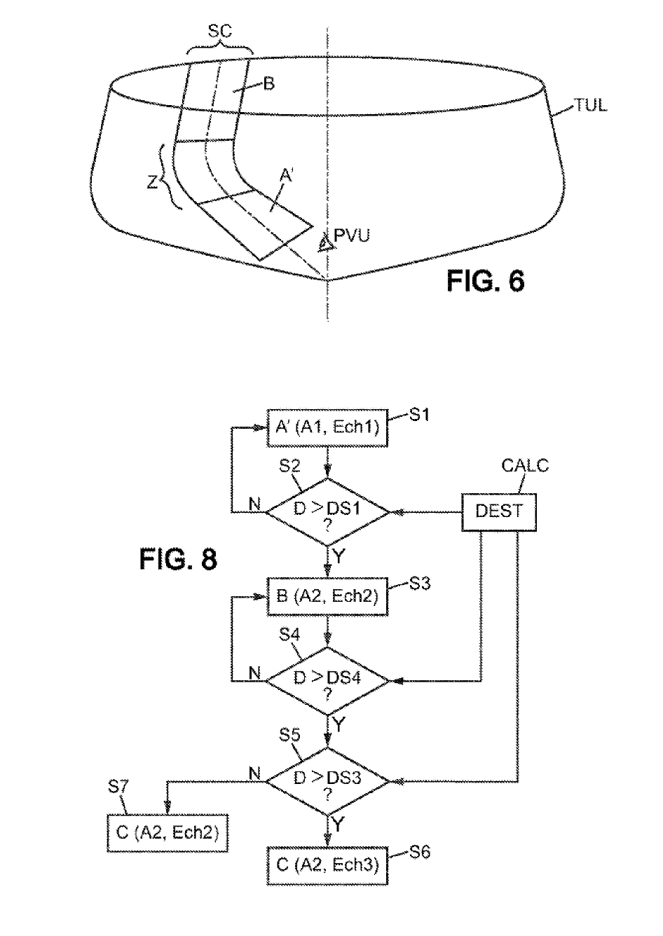

FIG. 6 illustrates a view in the space of the projections calculated by the module within the meaning of the invention for the display represented in FIG. 3;

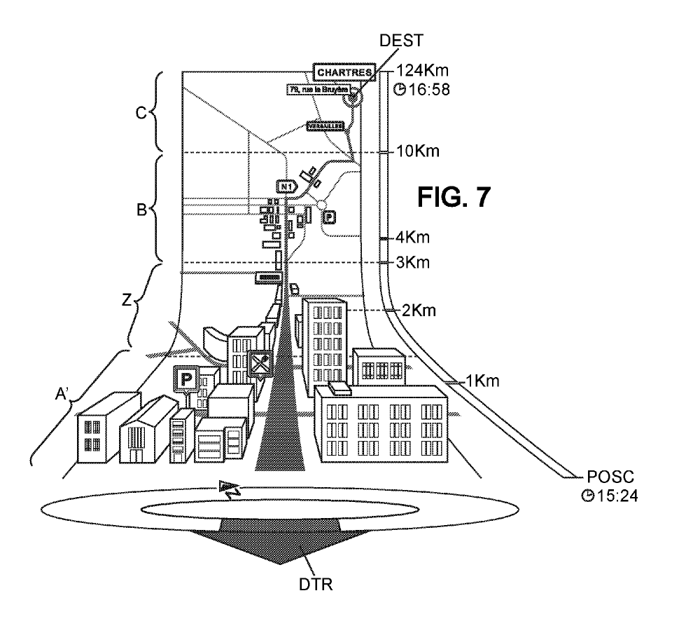

FIG. 7 illustrates a case of on-screen display in which the destination point is not in the continuity of the route represented in the first and second representations;

FIG. 8 summarizes a few steps of the method within the meaning of the invention, in an exemplary embodiment.

Represented in FIG. 1 is an exemplary device for aiding navigation between a current position point POSC and a destination point DEST. The device typically comprises:
storage means ST for data of at least one destination point DEST,
reception means REC for data of a current position point POSC (received for example by linking with a satellite),
a display screen ECR for aiding navigation of a user between the current position point POSC and the destination point DEST, and
means COM of controlling display on the screen ECR according to at least one 3D representation of a panorama facing the current position point according to a current direction of travel.

It is indicated here that the “current direction of travel” may be determined by a calculation module CALC capable of determining this direction of travel by comparison between a current position point POSC and a previous position point. In a practical embodiment, this calculation module CALC also defines a recommended route ITIN between the current position point POSC and the destination point DEST.

In particular, the device furthermore comprises:
means of comparison with a threshold distance DS of a distance from the current position point, and
a module TRAIT for processing display data on the screen, comprising means PERS for determining graphical perspectives A1-A2 as a function of this comparison so as to control a command (arrow PIL) of the on-screen display with at least the first aforementioned 3D representation and the second representation according to an angle of view A2 greater than the angle of view A1 of the first representation.

More precisely, the processing module TRAIT comprises the aforementioned means COM for controlling display on the screen ECR, as well as the means for determining graphical perspectives PERS. In particular, the control means COM construct the display data AFF as a function in particular of the command PIL of graphical perspectives determined by the means PERS.

In particular, in the example represented in FIG. 1, the calculation module CALC can perform the aforementioned comparison with the threshold distance DS of the distance from the current position point. In one embodiment, this threshold distance may be fixed, for example two kilometers, as will be seen in an exemplary embodiment illustrated in FIG. 3.

Except for the screen ECR, the elements of the device within the meaning of the invention may be realized by a processor PROC able to cooperate with a work memory MEM so as to store for example, temporarily at least, the aforementioned display data DAT during their processing by the module COM (for their construction in particular), before their communication to the screen ECR.

Represented in FIG. 2 is a detail of the display data AFF processing module TRAIT, which comprises in particular the means for determining graphical perspectives PERS as a function of the comparison with the threshold distance DS, so as to control (arrow PIL) a command of the on-screen display with at least the first aforementioned 3D representation, according to the angle of view A1, and the second representation according to the angle of view A2 (greater than the angle of view A1 of the first representation).

Preferably, the module PERS comprises means CONT for calculating graphical projections according to a continuous variation of angle of view between the first angle A1 and the second angle A2, so that the display comprises a continuous transition between the first and the second representation, with a continuous variation of angle of view from the first angle A1 to the second angle A2, as will be seen in detail with reference to FIGS. 4B and 6.

In an exemplary embodiment represented in FIG. 3, the second angle A2 is 90°, so that the second representation is then a 2D plan view of the panorama beyond the aforementioned distance threshold DS.

Thus, with reference now to FIG. 3, the display on the screen ECR then comprises, respectively from the bottom of the screen to the top of the screen:
a first 3D representation according to a perspective defined with a first angle of view A1 with respect to a chosen plane, of a panorama comprising the first buildings BATT and separated from the current position point POSC by a distance which is less than the threshold distance DS1, and
a second representation according to a perspective defined with a second angle of view A2, here 90°, with respect to said chosen plane, of a panorama comprising second buildings BAT2 and separated from the current position point by a distance which is greater than the threshold distance DS2,
   the first angle A1 (chosen for example in a range from 30 to 45°) being less than the second angle A2 (90° in the example described).

Of course, the threshold distance DS2 is greater than the threshold distance DS1.

Represented in FIG. 3 is an exemplary axis of distance DIST from the current position point POSC. Several notable distances from the current position point POSC will then be noted:
a threshold distance DS1 below which the representation is three-dimensional (3D) with an angle A1 of perspective of for example 30°, and
another threshold distance DS2 beyond which the representation is of “bird's eye view” type, therefore two-dimensional (2D), with an angle A2 of view of 90°.

In particular, between these two threshold distances DS1 and DS2, the transition of angle of view from 30° to 90° is continuous.

Thus, with reference to FIG. 4B, the vanishing point PF with respect to the (virtual) viewpoint of the user PVU forms an angle A1 with a horizontal plane PH1, for the first 3D representation. On the other hand, this angle A1 becomes the angle A2 of FIG. 4B for the second representation, with the angle A2 equal to 90° with respect to the plane PH2 supporting the second buildings. Furthermore, the vanishing point of the second representation is shifted toward infinity facing the viewpoint PVU, to become a 2D representation according to a plan view.

It will be noted in the zone Z (corresponding to the intermediate distances between the thresholds DS1 and DS2) that the transition between the angle A1 and the angle A2 is continuous. In particular, with respect to the (virtual) viewpoint of the user PVU, with reference to FIG. 6, the representations on the screen ECR follow one another according to a concave surface SC inscribed in the inner wall of a tulip shape TUL. On the basis of the current position point POSC, the user can thus view a portion of the total panorama surrounding him (over 360°). This “portion” of panorama corresponds to his field of vision. The viewpoint of the user PVU is then in the heart of the aforementioned tulip. By swiveling around, the user views the panorama portion corresponding to his current field of vision.

It will thus be understood that the processing module within the meaning of the invention advantageously calculates graphical projections according to the graphical perspectives defined by the angles A1 and A2, so as to establish the aforementioned 3D and 2D representations, as well as a representation of the continuous transition zone Z between these two 3D and 2D representations.

In an exemplary embodiment, a first projection for the 3D representation can be performed on a plane according to an angle of for example 15°. For the three-dimensional representation in particular of the buildings according to this first projection, available maps give:
the layout of the buildings on the ground: thus, the position coordinates of each building on the ground are known,
and the altimetry of the buildings: thus, on the basis of the known ground plot and of the known altitude of the buildings, it is possible to generate the 3D volumes of the buildings by extrusion.

Thus, in generic terms, the first 3D representation comprises a representation by volumes, at least of buildings of the aforementioned panorama (immediate panorama in proximity to the current position point).

Thereafter, a second projection may be performed for the transition zone Z, onto a portion of hollow cylinder (FIG. 6), corresponding in section to a circular arc of for example 75° (corresponding to 90° of the 2D plan view, less the angle of 15° used for the “bird's eye view” 3D representation). Thus, the method in this exemplary embodiment comprises, for the display of the continuous transition between the first 3D representation and the second plan view representation, a projection onto a portion of hollow cylinder, comprising, according to a sectional view, a circular arc of less than 90°.

A third projection may be performed for the 2D representation, of cartographic type, in a plan view (at 90° to the eye of the user PVU), therefore on a vertical plane.

FIG. 3 also shows a change of representation scales. Indeed:
the first 3D representation (bearing the reference A′ in FIG. 4A) is to a first scale Ech1 for the distances reckoned from the current position point POSC, which are less than the threshold DS1, and
the second representation (bearing the reference B in FIG. 4A) is to a second Ech2 for the distances reckoned from the current position point POSC, which are greater than the threshold DS2,

the second scale Ech2 being greater than the first scale Ech1.

With reference again to FIG. 3, the display furthermore comprises, at the top of the screen, a third representation (bearing the reference C in FIG. 4A) including the destination point DEST. This third representation is performed according to a perspective defined with the second angle of view A2 (for example 90°) and especially with a scale Ech3 which is greater than or equal to the scale Ech2 of the second representation B.

In particular, the method within the meaning of the invention comprises in the example described here an additional processing of the display data so as to modify the scale of the third representation C as a function of a distance separating the current position point POSC from the destination point DEST. Thus, for distances greater than a threshold distance DS3, the representation scale corresponds to the scale Ech3, larger than the scale Ech2 of the second representation B between the distances DS2 and DS3.

In a particular exemplary embodiment illustrated in FIGS. 5A to 5D, the transition between the scales Ech2 and Ech3 is not continuous. Thus, as long as the distance separating the current position point POSC and the destination DEST is greater than the threshold distance DS3, the representation C is performed with the scale Ech3 (FIG. 5A). On the other hand, if this distance becomes less than the threshold DS3 (FIG. 5B), the scale of the representation C becomes the scale Ech2 of the representation B.

Thus, the method comprises a processing of the display data as a function of a second threshold distance DS3 from the current position point POSC, defining:
a scale Ech3 of the third representation C which is greater than the scale Ech2 of the second representation B if the current position point POSC is separated from the destination point DEST by a distance which is greater than the second threshold distance DS3, and
a scale Ech2 of the third representation C which is equal to the scale of the second representation B if the current position point POSC is separated from the destination point DEST by a distance which is less than the second threshold distance DS3.

In the example represented in FIG. 5C, if the distance separating the current position point POSC and the destination DEST becomes even less than another threshold DS4, the third representation C can disappear and only the representations A′ and B remain. Thereafter, with reference now to FIG. 5D, if the distance separating the current position point POSC and the destination DEST becomes less than the first threshold DS1 of FIG. 3, the second representation B can also disappear and only the representation A′ remains until arrival at the destination.

The function of the third representation C is to indicate the destination point. It will be understood that no continuity necessarily exists between the second representation B and the third representation C. FIG. 7 illustrates this principle most particularly. In the example represented, the recommended route consists in firstly making an about-turn as indicated by the arrow DTR. It will nonetheless be noted that the panorama facing the user according to the representations A′ and B continues to be displayed but that on the other hand, the destination point DEST is now presumed to be behind the user's back. Nevertheless, it is displayed in the representation C.

Steps of processing the graphical data of an exemplary embodiment of the method within the meaning of the invention have been summarized in FIG. 8. Without necessarily specifying a destination DEST or without receiving data about the destination DEST, the device of the invention displays by default in step S1 the representation A′ according to the angle of view A1 and to the scale Ech1. Thereafter, if a destination is specified, the module CALC (FIG. 1) determines the distance D separating the current position point from the destination point DEST and if this distance D is greater than the aforementioned threshold DS1 (arrow Y on exit from the test S2), a display setting is constructed in step S3 to control a display:
according to the first representation A′, and
according to the second representation B with the angle of view A2 and the scale Ech2.

Thereafter, if the distance D is furthermore greater than the aforementioned threshold DS4 (test S4), but still less than the threshold DS3 (arrow N on exit from the test S5), a display setting is constructed in step S7 to control a display:
according to the first representation A′ with the angle of view A1 and the scale Ech1,
according to the second representation B with the angle of view A2 and the scale Ech2, and
according to the third representation C with the angle of view A2 and the scale Ech2.

On the other hand, if the distance D is greater than both the threshold DS4 (test S4) and the threshold DS3 (arrow Y on exit from the test S5), a display setting is constructed in step S6 to control a display in particular of the third representation C with the angle of view A2 but with the scale Ech3.

The present invention therefore affords a mixed representation of 2D cartography and of 3D navigation. The screen ECR displays more particularly a 3D close-up depiction with a presentation of the more distant information in plane mode (2D). In an exemplary embodiment provision is made for continuity of reading between the 3D and the 2D, therefore from a volume depiction to a plane depiction.

Moreover, again in an exemplary embodiment, three fragmented representations or depictions of one and the same route are displayed simultaneously and in a concomitant manner in one and the same interface:
a representation in close-up depiction (zone A′), displayed in 3D (therefore volume-wise) which offers reading that is closer to reality, therefore better apprehension and recognition of places; correspondences (or “mappings”) of textures, or photos of the actual buildings may be applied to the 3D volumes,
an intermediate depiction (zone B) which offers purged and plane reading; its representation is in the form of a drawn or realistic plane in photographic form (aerial or satellite);
a distant depiction (zone C) according to a principle of display identical to intermediate depiction but with a greater or equal scale.

The user is thus afforded an indication of:
his position at the present instant according to the close-up depiction in 3D,
the immediate position to which he is going according to the 2D distant depiction with for example the next change of direction if there is reason (for example the arrow recommending a right turn in 5350 meters in FIG. 3), and
the destination position according to an even more distant depiction in 2D.

Furthermore, provision may be made for a transition zone Z between the 3D close-up and 2D distant depiction of the zone B.

The continuous transition between the 3D depiction and the 2D intermediate depiction, although optional, presents advantages:
it facilitates apprehension of the present context in which the user finds himself and
thereafter allows better projection of the user with respect to the future environment.

While inputting the destination, the user can directly view the whole of his journey. The on-screen display then uses, in an exemplary embodiment, three scales which allow an, optionally global, extended view of the route.

As described previously with reference to FIGS. 5A to 5D, the use of various distance scales allows the display of large distances. The scale of the 3D zone (zone A′) is preferably fixed and this is the smallest scale among the representations on the screen, the scales of the other representations B and C being larger.

Thus, the 3D close-up depiction (zone A) is to fixed-scale allowing realistic depiction of the places (buildings, local geographical reliefs, and others). The plane middle depiction (zone B) is to intermediate scale and the plane distant depiction (zone C) is to large scale and can adapt to the distance remaining to the destination point.

Labels designating a restaurant and a parking area will be noted on the left of FIG. 3 in the example represented. Preferably, the more distant an element of the graphic (such as a building or a road), the more purged is the information associated with this element. The information displayed on the screen is hierarchized according to the distance scale: the larger the scale, the less information the screen displays (for example the main streets and the secondary streets for a given scale and only the main streets for a larger scale).

The indication of the destination point in the zone C to large scale allows ambiguity resolution. Indeed, when the user inputs a destination, the device displays the whole of the user's future journey up to the zone C, thereby allowing ambiguity resolution for example regarding destinations having one and the same name but in different counties or countries.

Of course, the present invention is not limited to the embodiment described hereinabove by way of example; it extends to other variants.

Thus, it will be understood for example that the aforementioned transition zone Z between the representations A′ and B may be omitted in a less sophisticated embodiment in which the transition between the representations A′ and B is abrupt.

Likewise, the third representation C described hereinabove is optional and may be omitted in a less sophisticated embodiment. It nonetheless makes it possible to permanently view the destination point toward which the device within the meaning of the invention indicates the route.

Fixed distance thresholds DS1 (of 2 km from the current position POSC), DS2 (3 km), DS3 (10 km) have been described hereinabove. However, in a more sophisticated variant, these thresholds can depend on the distance to be covered in order to reach the destination DEST. The scales of the second and third representations Ech2 and Ech3, in particular, can then be adapted as a function of the calculated thresholds DS2 and DS3. For example, if the destination is at 20 km, the threshold DS2 may be at 3 km and the threshold DS3 at 10 km. On the other hand, if the destination is at 130 km, the threshold DS2 may be at 3 km and the threshold DS3 at 30 km, thereby involving an increase in scale in particular of the third zone C by a factor of 10.

Moreover, the first aforementioned representation, termed “3D”, is generally a representation of the volumes. It may entail a representation according to a chosen angle A1 with a perspective complied with as described hereinabove with reference to the figures. In a possible variant, it may entail an axonometric perspective (termed “isometric perspective”) view. In this case, it may be chosen to represent first buildings of the panorama according to this isometric perspective with a first scale, background buildings with a larger scale, and so on and so forth until the representation B in bird mode.

An application to navigational aid for a vehicle in particular has been described hereinabove. However, the invention admits variant applications, for example in cartography for video games or for simulators.

1. A method for processing on-screen display data for aiding orientation between a current position point and a destination point, the on-screen display comprising at least one 3D representation of a panorama facing said current position point according to a current direction of travel,
the method comprising:
comparing a distance from the current position point, with at least one threshold distance, and
processing display data, as a function of said comparison, so as to control a command of the on-screen display with at least, respectively from the bottom of the screen to the top of the screen:
a first 3D representation according to a perspective defined with a first angle of view with respect to a chosen plane, of a panorama separated from the current position point by a distance which is less than said threshold distance, and
a second representation according to a perspective defined with a second angle of view with respect to said chosen plane, of a panorama separated from the current position point by a distance which is greater than said threshold distance,
the first angle being less than the second angle.

2. The method as claimed in claim 1, wherein the second angle is 90°, and in that the second representation is a 2D plan view.

3. The method as claimed in claim 1, wherein the display comprises a continuous transition between the first and the second representation, with a continuous variation of angle of view from the first angle to the second angle.

4. The method as claimed in claim 3, comprising, for the display of the continuous transition between the first and the second representation, a projection onto a portion of hollow cylinder, comprising, according to a sectional view, a circular arc of less than 90°.

5. The method as claimed in claim 1, wherein the first 3D representation comprises a representation in volumes at least of buildings of said panorama.

6. The method as claimed in claim 1, wherein the first 3D representation and the second representation are respectively to a first scale and to a second scale, the second scale being greater than the first scale.

7. The method as claimed in claim 1, wherein the display further comprises, toward the top of the screen, a third representation including said destination point, according to a perspective defined with said second angle of view and with a scale greater than or equal to a scale of the second representation.

8. The method as claimed in claim 7, comprising a processing of the display data so as to modify the scale of the third representation as a function of a distance separating the current position point from the destination point.

9. The method as claimed in claim 8, comprising a processing of the display data as a function of a comparison of a distance from the current position point with a second threshold distance, defining:
a scale of the third representation which is greater than the scale of the second representation if the current position point is separated from the destination point by a distance which is greater than the second threshold distance, and
a scale of the third representation which is equal to the scale of the second representation if the current position point is separated from the destination point by a distance which is less than the second threshold distance.

10. A non-transitory computer program storage medium, storing instructions for the implementation of the method as claimed in claim 1, when the program is run by a processor.

11. A module for processing on-screen display data for aiding orientation between a current position point and a destination point,
the on-screen display comprising at least one 3D representation of a panorama facing said current position point according to a current direction of travel,
the module comprising means for controlling, as a function of an estimated distance from the current position point, a control of the on-screen display with at least, respectively from the bottom of the screen to the top of the screen:
a first 3D representation according to a perspective defined with a first angle of view with respect to a chosen plane, of a panorama separated from the current position point by a distance which is less than a threshold distance, and
a second representation according to a perspective defined with a second angle of view with respect to said chosen plane, of a panorama separated from the current position point by a distance which is greater than the threshold distance,
the first angle being less than the second angle.

12. A device for aiding orientation between a current position point and a destination point, comprising:
storage means for data of at least one destination point,
reception means for data of a current position point,
a display screen for aiding orientation between a current position point and a destination point, and
a module for controlling display on the screen according to at least one 3D representation of a panorama facing said current position point according to a current direction of travel,
the device further comprising:
means for comparing a distance from the current position point, with at least one threshold distance, and
a module for processing display data on the screen, comprising means v for controlling, as a function of said comparison, a control of the on-screen display with at least, respectively from the bottom of the screen to the top of the screen:
a first 3D representation according to a perspective defined with a first angle of view with respect to a chosen plane, of a panorama separated from the current position point by a distance which is less than the threshold distance, and
a second representation according to a perspective defined with a second angle of view with respect to said chosen plane, of a panorama separated from the current position point by a distance which is greater than the threshold distance,
the first angle being less than the second angle.
